(19) United States
(12) Patent Application Publication
(10) Pub. No.: US 2006/0106180 A1
(43) Pub. Date: May 18, 2006

(54) Polymeric stabilizing agent for water-in-oil polymerization processes

(75) Inventors: Ivan Pantchev, Chavannes/Renens (CH); David Hunkeler, Founex (CH)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: AquaSpecialties S.A.

(21) Appl. No.: 10/991,628

(22) Filed: Nov. 18, 2004

(51) Int. Cl. C08F 120/54

(52) U.S. Cl. 526/303.1; 526/317.1; 526/319; 526/286; 526/310

(57) ABSTRACT

The invention comprises a polymeric amphiphilic stabilizing agent and its use in the inverse-emulsion and inverse-suspenion polymerization of acrylic monomers. The stabilizing agent produces inverse-emulsions and inverse-suspensions having good stability, polymers with high molecular weights, high solid content, low coagulum and which can be branched providing a means to prepare branched, or structured, dry polymers. The stabilizing agent is amphiphilic copolymer that is prepared from a mixture of linear alkylmethacrylates monomers and acrylic or methacrylic acid co-monomers. Typically, the mixture of alkylmethacrylates is comprised of esters having alkyl moieties that are from 14 to 20 carbon atoms in length. The stabilizing agent copolymers typically have number average molecular weights from about 500 to 50,000 g/mol, or weight average molecular weights from 50,000 to 100,000 g/mol.

### BACKGROUND OF THE INVENTION

The present invention relates to stabilizing agents that are useful in inverse-emulsion and inverse-suspension polymerization processes and processes of using the same.

Environmental regulations continue to focus upon reducing the level of contaminations in water effluent from industrial plant and municipal wastewater. Various aqueous solutions of water-soluble acrylamide polymers and acrylamide-based copolymers have been developed to treat effluent wastewater.

In particular, water-soluble anionic acrylamide polymers have been used in the treatments of industrial wastewater, flocculants in the mining industry, and as mobility control agents that enhance oil recovery. U.S. Pat. Nos. 4,034,809 and 5,530,069 describe using anionic acrylamide polymers in secondary and tertiary oil recovery. Acrylamide based copolymers having different cationic copolymers are widely used in the treatment of municipal wastewater.

Generally, as the molecular weight of an acrylamide-based polymer increases, the solution viscosity is also greatly increased. This can cause problems in large-scale synthesis including nonuniform mixing, heat transfer limitations, and particle overheating. To overcome these difficulties, acrylamide polymers are often commercially synthesized through heterophase water-in-oil polymerization processes. Typically, these processes permit polymerizations at higher solid concentrations, low viscosities, and with better temperature control. Two categories of heterophase polymerization include inverse-macroemulsion and inverse-microemulsion polymerization. Both polymerizations produces a water-in-oil emulsion that contains the water-soluble polymer in the aqueous phase. The significant differences between inverse-macroemulsions and inverse-microemulsions are summarized below. Inverse-macroemulsions are generally kinetically stable, which means that they will typically settle over a period of-months. Inverse-macroemulsions are normally a white-opaque color and are typically stabilized with a surfactant ranging in concentration from about 0.1 to 5% by weight of the total system. If the concentrations of surfactant are on the low end, usually from about 0.1 to 1 wt %, the inverse-macroemulsion is referred to as an “inverse-suspension”, while for surfactant concentrations typically between about 2 and 5%, the systems are referred to as “inverse-emulsions”. In contrast, “inverse-microemulsions” are produced at much higher levels of stabilizing agent, typically from about 8 to 30 wt %, can often be transparent, and are thermodynamically stable, implying that they will not settle, even over a period of years.

The majority of acrylamide-based polymers are produced commercially using inverse macroemulsion polymerizations. A typical commercial recipe includes a continuous aliphatic or aromatic organic phase, a mixture of emulsifiers to achieve an HLB between 4 and 6, monomer(s), water, chemical initiator(s), and additives. Monomer(s) typically include acrylamide, anionic species such as acrylic and methacrylic acids, and quaternary ammonium acrylics. Methods of preparing inverse emulsions are described in U.S. Pat. No. 3,284,393.

Typical water-soluble anionic acrylamide polymers include polyacrylamide copolymers comprising monomers such as acrylic acid, methacrylic acid, itaconic acid, and the like. The amount of anionic component in the acrylamide copolymers is typically from about 5 to 50 molar percent and can even be as great as 90 mol percent. The total solids level in embodiments having a higher percentage of anionic component maybe reduced because of viscosity limits. U.S. Pat. No. 4,875,935 describes acrylic acid and methacrylic acid polymers as particularly useful.

The Journal of Colloid and Interface Science 197, 317-326 (1998) discusses that it is possible in systems with ultra low interfacial tension to have an inverse-microemulsion that is a thermodynamically stable system. However, conventional inverse macroemulsions, which includes inverse emulsions and suspensions, are typically thermodynamically unstable and turbid. It is believed that microemulsions are more stable than inverse emulsions and suspensions because inverse-microemulsions typically use greater amounts of surfactants. As a result, microemulsions are formed that typically have smaller particles and settle much more slowly or not at all.

Various methods have been developed to help improve stabilization of macroemulsions. Typically, water-soluble surfactants dissolve rapidly in water and help provide a convenient method for preparing aqueous solutions of the polymer. U.S. Pat. No. 3,624,019 describes adding a water-soluble surfactant to the emulsion to improve the rapid dissolution of the polymer into the aqueous phase.

U.S. Pat. No. 4,506,062 describes the use of a stabilizer that helps emulsify the monomeric material. In particular, the reference describes an inverse-suspension stabilizer that is comprised of a copolymer on the base of cetostearyl methacrylate and methacrylic acid or trimethyl-beta-methacryloxy-ethylammonium methosulfate. The charge of the stabilizer is opposite to the charge of the polymerizable water-soluble monomer.

After polymerization, water-in-oil polymeric inverse-macroemulsions and inverse-microemulsions are typically converted into either an aqueous solution or a dry powder. For direct application, the water-in-oil system is inverted using a suitably high HLB surfactant so that the polymer/copolymer is dissolved into an aqueous continuous phase. To prepare a dry powder, large quantities of the organic phase must be removed, followed by evaporation of the water phase.

Inverse-suspension particles can be dried to a powder by a number of processes including spray drying, fluidized bed drying, and rotary dryers. Currently, there is no known or published method of preparing and drying powdered particles from a branched inverse-suspension. While the preparation of inverse-suspensions, inverse-emulsions, and inverse-microemulsion polymerizations have been generally described using crosslinking or branching agent(s), the transformation of these heterophase water-in-oil systems to a dry state has been problematic.

The preparation of dry powders may be desirable for many applications such as paper manufacturing. The advantages of structured, branched, and crosslinked water-soluble polymers are discussed in U.S. Pat. Nos. 6,294,922, 6,617,402, and 6,667,334.

At present, such advantages are limited to applications where a water-in-oil based polymeric material can be applied. It would be useful to extend this range to systems where powders are either required or preferred.

Powders can typically be prepared from the drying of water-in-oil based systems, directly via polymerization on a belt initiated physically (e.g., by UV or another radiation source of a different wavelength) or via precipitation from solution using an organic solvent, which is generally polar such as isopropylalcohol, acetone, or ethanol. For the physical and solution processes, the introduction of branching agents tends to result in formation of an undesirable gel, which either renders the entire, or part of, the final polymer insoluble. The presence of gel is undesirable in applications typical for flocculants, such as solid-liquid separations, because the insoluble portion is generally ineffective and may also clog equipment. As a result, current methods of preparing powders, discussed in the prior art, cannot be easily coupled with existing heterophase water-in-oil polymerizations.

A second disadvantage associated with inverse emulsion polymerization is the amount of coagulum that can be formed during polymerization. The production of coagulum can occur if the stability of the inverse-emulsion is decreased. The formation of coagulum during the synthesis of polyacrylamide homopolymers or copolymers may result in lost product and the necessity to clean the reactor. As a result, the efficiency of synthesizing the polymer can be adversely affected.

Although a variety of different methods have been developed to improve inverse-emulsion and inverse-suspension stability, there still exists a need to produce inverse-emulsions and inverse-suspensions having good stability, high polymeric content, low degree of coagulum, polymers having high molecular weights, and that can more efficiently be converted into powders. Additionally, there is a further need for branched powders prepared from inverse-suspensions.

### BRIEF SUMMARY OF THE INVENTION

The invention comprises a stabilizing agent that is particularly useful for the polymerization of acrylamide monomers in inverse-emulsions or inverse-suspensions. In particular, the stabilizing agent is useful for preparing inverse macroemulsions containing acrylamide-based polymers having good stability, high molecular weight, high polymeric content, and that are substantially free of coagulum. The stabilizing agent may be used in inverse-emulsion polymerization of anionic monomers, and in inverse-suspension polymerization of both anionic and cationic acrylic monomers. The stabilizing agent can also be used to prepare linear and branched polymers from cationic acrylic monomers.

The stabilizing agent is a copolymer that is comprised of a mixture of hydrophobic methacrylate ester monomers and hydrophilic acrylic or methacrylic acid co-monomers. The methacrylate ester monomers are a mixture of methacrylate esters that have ester groups that vary in length from about 14 to 20 carbon atoms. A particularly useful methacrylate mixture is comprised of about 90 to 98% ester groups having 16 to 18 carbon atoms. The hydrophilic monomers are comprised of acrylic acid, methacrylic acid, or blends thereof.

It has been found that the stabilizing and emulsifying effects of the stabilizing agent are increased when the alkyl groups of the methacrylate esters have varying lengths. Stabilizing agent copolymers that are in accordance with the invention should typically have number average molecular weights from about 500 to 50,000 g/mol and weight average molecular weights from 50,000 to 100,000 g/mol. Typically the amount of hydrophobic and hydrophilic components are present in a ratio from about 95:5 to 30:70 mol percent.

In another aspect of the invention, the stabilizing agent can be combined with other surfactants such as sorbitan esters of fatty acids, alcanol amides, fatty acid glycerides, glycerin ester, as well as ethoxylated versions of the above mentioned compounds. The stabilizing agent can also be combined with surfactants having high or low HLB. Typically, the HLB of the surfactants will be from about 2 to 11.

The invention also includes a polymeric inverse-emulsion or inverse-suspension that contains polymeric material and the stabilizing agent. The stabilizing agent is typically present in the inverse-emulsion and inverse-suspension from about 0.1 to 1 weight percent dry polymer based on the total weight of the inverse- emulsion or inverse-suspension.

The polymeric material typically comprises acrylamide monomer and anionic or cationic co-monomers. The final polymer emulsions should contain from about 35 to 45 percent solid polymer content and should have substantially no coagulum. The acrylamide-based polymers prepared in accordance with the invention can be linear or branched and have molecular weights that are about 7,000,000 g/mol or greater, based on measurement methods such as correlations estimating molecular weight from intrinsic viscosity. Inverse-suspensions prepared in accordance with the invention typically have a solid content that is from about 15 to 30 weight percent based on the total weight of the suspension.

Thus, the invention provides an improved stabilizing agent for producing inverse-emulsions and inverse-suspensions containing acrylamide-based polymers having high molecular weights, good stability, high solid content, substantially free of coagulum, and that can be converted into powders.

### DETAILED DESCRIPTION OF THE INVENTION

The invention may be embodied in many different forms and should not be construed as limited to the embodiments set forth herein; rather, these embodiments are provided so that this disclosure will satisfy applicable legal requirements.

The invention is a polymerizable inverse-emulsion or inverse-suspension comprising a stabilizing agent that results in substantially no coagulum, high polymer content, polymers having high molecular weights, and polymers in dry form that may be branched.

Typically, inverse-emulsions and inverse-suspensions that are in accordance with the invention comprise an oil phase; an aqueous phase; water-soluble monomeric materials; the stabilizing agent; and additional ingredients that can help polymerize or emulsify the aqueous phase.

Preparation of the polymeric inverse-emulsion or inverse-suspension may begin with forming an aqueous and oil phase. Typically, the oil phase will contain the stabilizing agent, and the water-soluble acrylamide monomer and cationic/anionic co-monomers are in the aqueous phase. A homogenizer can be used to help emulsify the aqueous mixture into the organic phase, although in some cases this may not be necessary. An initiator may be used to begin the polymerization of acrylamide-based monomers.

The stabilizing agent is typically an amphiphilic random copolymer that is comprised of hydrophobic and hydrophilic monomers. The hydrophobic monomers are typically a mixture of methacrylate esters having the following structure:

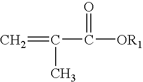

wherein R₁ is typically an alkyl group having from 14 to 20 carbon atoms, and somewhat more typically from 16 to 18 carbon atoms, such as hexadecylmethacrylate (C16) and octadecylmethacrylate (C18).

The hydrophilic monomer is typically an acrylic or methacrylic acid having the following structure:

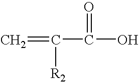

wherein R₂ is CH₃ or H. The hydrophilic component can be comprised solely of methacrylic acid or acrylic acid, or blends thereof. Copolymers prepared from methacrylic and acrylic acid typically contain from about 5 to 15 mol percent methacrylic acid and from about 15 to 5 mol percent acrylic acid. The total sum of the acrylic acid and methacrylic acid components varies between 5 and 20 mol %.

It has been discovered that the stabilizing properties of the stabilizing agent are improved by preparing the amphiphilic copolymer from a mixture of linear alkylmethacrylates with different lengths of the hydrophobic moieties. Typically, the hydrophobic component may comprise a mixture of methacrylate esters wherein the alkyl within the ester moiety has about 14 to 20 carbon atoms. A particularly useful stabilizing agent is comprised of methacrylate esters wherein about 90 to 98% of the methacrylate esters have alkyl moieties that are from 16 to 18 carbon atoms in length. The methyacrylate esters may be prepared from linear alcohols that are from 14 to 20 carbon atoms in length. Suitable methacrylate ester monomers include, without limitation, hexadecyl methacrylate, octadecyl methacrylate, tetradecyl methacrylate, and eicosyl methacrylate.

It has been discovered that the emulsifying properties of the stabilizing agent are improved when the mixture of methacrylate esters is comprised of ester groups having differing lengths.

Typically, the broader the molecular weight distribution of the copolymer, the better the stabilizing agent can stabilize and emulsify acrylamide based polymers. The same trend is also generally observed when increasing the length of the alkyl groups in the alkylmethacrylate monomers. For example, when a hydrophobic co-monomer, such as lauryl methacrylate only is used, the stabilizing effect decreases with the used dispersant concentrations. The stabilizing agent typically has a number average molecular weight that is from about 500 to 50,000 g/mol with a weight average molecular weight between 50,000 and 100,000 g/mol. The molecular weight distribution typically has a polydispersity from about 2 to 6, and somewhat more typically between 5 and 6. Polydispersity can be measured by size exclusion chromatography (GPC). Observations have generally shown that high molecular weight copolymers may cause decreased suspension stability. While not wishing to be bound by theory, it is believed that a probable reason for the decreased stability results from particle coalescence due to a bridging flocculation in case of polymer molecular weights higher than 100 000 g/mol.

The amount of the hydrophobic component to hydrophilic component can be varied from about 95:5 to 30:70 mol percent. Typically, the ratio of hydrophobic to hydrophilic component is from about 95:5 to 80:20, and somewhat more typically, from about 90:10 to 80:20 mol percent.

The synthesis of the stabilizing agent can be performed in an aliphatic hydrocarbon solvent using conventional oil-soluble initiators. The initiator concentration can vary from about 0.1 to 0.3 mol percent, and is typically from about 0.1 to 0.2 mol percent based on the total molar content of the monomers. Typically, the synthesis is performed for 8 hours at temperatures from about 60° C. to 90° C.

Tables 1a and 1b below, illustrate some of the physical properties of stabilizing agents that are prepared in accordance with the invention. From the data in Tables 1a and 1b, it should be apparent that as the amount of acrylic acid within the stabilizing agent is changed, the physical properties of the stabilizing agent are affected. In particular, as the percentage of acrylic acid is increased, the size of the micelles from which the stabilizing agent is formed are reduced. The size of the stabilizing agent in solution can be characterized by its molar mass, intrinsic viscosity, and radius of gyration. Table 1b is a comparative table illustrating other stabilizing agents that can be synthesized in accordance with the invention. The stabilizing agents included in Table 1b were not used in the examples.

TABLE 1a
Properties of Stabilizing agents Employed in the Examples

| | | | | | Weight | | Weight |
|---|---|---|---|---|---|---|---|
| | Hexadecyl- | Octadecyl. | | Meth- | Average | | Average |
| Stabilizing | Methacry- | Methacry- | Acrylic | acrylic | Molecular | Intrinsic | Radius of |
| Agent | late | late | Acid | Acid | Weight | Viscosity | Gyration |
| Name | (mol %) | (mol %) | (mol %) | (mol %) | (kDa) | (dl/g) | (nm) |
| IB 14 | 21.5 | 64.5 | 14 | 0 | 89 | 0.25-0.30 | 8.7 |
| IB 5000 | 21.5 | 64.5 | 14 | 0 | 75 | 0.22-0.36 | 7.9 |
| MA 10 | 22.5 | 67.5 | 0 | 10 | — | — | — |

* IB 5000 is a large-scale version of IB 14, illustrating that passing from the 0.5 to 5.0 L scale does not, significantly, influence properties.

TABLE 1b
Properties of Comparative Stabilizing Agents Synthesized

| | | | | | Weight | | Weight |
|---|---|---|---|---|---|---|---|
| | Hexadecyl- | Octadecyl. | | Meth- | Average | | Average |
| Stabilizing | Methacry- | Methacry- | Acrylic | acrylic | Molecular | Intrinsic | Radius of |
| Agent | late | late | Acid | Acid | Weight | Viscosity | Gyration |
| Name | (mol %) | (mol %) | (mol %) | (mol %) | (kDa) | (dl/g) | (nm) |
| IB 5 | 23.75 | 71.25 | 5 | 0 | 137 | 0.35 | 11.3 |
| IB 30 | 21.5 | 64.5 | 30 | 0 | 74 | 0.15 | 7.1 |
| IB 40 | 22.5 | 67.5 | 40 | 0 | 54 | 0.07-0.12 | 5.6 |

The stabilizing agents described in Tables 1a and 1b are copolymers synthesized from the mixture of methacrylate esters and acrylic acid monomers.

In the case of inverse-suspensions, it has been discovered that the addition of water-soluble alkyl quaternary ammonium salts, having charges opposite to the charge of the stabilizing agent can improve the stabilization of the inverse-suspension. While not wishing to be bound by theory, the applicants believe that the improved stabilization may result from a complex formation between the stabilizer and the salt, which reduces the interfacial tension between the oil and water phases. It is believed that the attraction of opposite charges on the salt and the polymeric stabilizing agent accelerates and increase the release of the stabilizing agent's molecules at the interface.

Octadecyltrimethylammonium chloride is a useful quaternary ammonium salt. Typically, the amount of quaternary salt present in the inverse-suspension is from about 0.001 to 0.03 weight percent, based on the total weight of the suspension. The decrease of the interfacial tension between the oil and water phase with the presence of quaternary ammonium salt in combination with the stabilizing agent compares well with standard surfactants such as sorbitan sesquioleate. Therefore, it can be expected that quaternary ammonium salt in combination with the stabilizing agent may be also be used to stabilize an inverse-emulsion.

Stabilizing agents in accordance with the invention are typically present in the inverse-emulsion or inverse-suspension in an amount that is from about 0.1 to 2.5 weight percent based on the total weight of the emulsion or suspension, and more preferably from about 0.1 to 1.0 weight percent based on the total weight of the inverse-emulsion or inverse-suspension. For inverse-suspensions the amount of stabilizing agent is preferably up to about 1.0 weight percent based on the total weight of the suspension, and more preferably up to about 0.5 weight percent.

The stabilizing agent can also be combined with conventional surfactants to produce a stabilizing blend having improved stabilizing properties. In some embodiments, the blend may be comprised of about 50 to 80 weight percent conventional surfactants with an HLB from about 3.5 to 6. In other embodiments the stabilizing agent may be combined with a conventional surfactant having an HLB from about 2 to 11. The amount of conventional surfactant in the combination is typically from about 80 to 90 weight percent based on the total weight of the combination.

Alternatively, the blend can be comprised of about 10 to 30 weight percent conventional surfactants with an HLB from about 9 to 11, such as polyoxyethylene (20) sorbitan trioleate, polyoxyethylene (20) sorbitol haxaoleate, etc. The amount of stabilizing blend added to the inverse-emulsion is preferably from about 1 to 2.5 weight percent based on the total weight of the inverse-emulsion.

For inverse-suspensions, the stabilizing agent may be combined with one or more conventional surfactants having a low HLB that is typically from about 3 to 6, such as sorbitane monoisostearate, sorbitane oleate, and the like. The amount of surfactant combined with the stabilizing agent is typically up to about 85 weight percent based on the total weight of the combination. This combined stabilizing blend can be useful for preparing inverse-suspensions containing acrylamide monomers and different anionic or cationic co-monomers. It should be apparent that a wide variety of different surfactants may be used in the practice of the invention including surfactants comprising fatty acid esters and ethoxylated fatty acid esters. Preferably, the amount of stabilizing blend added to inverse-suspension is in the range from about 0.1 to 1 weight percent based on the total weight of the suspension, with 0.25 to 0.7 percent being somewhat more preferred.

The oil phase can be comprised of a broad variety of organic liquids. The oil phase can be any inert aliphatic and/or aromatic hydrophobic liquid which does not interfere with the polymerization reaction. Examples of these hydrophobic liquids include, without limitation, benzene, xylene, toluene, isoparaffinic oils, kerosenes, naphtas, and the like, and mixtures thereof. Particularly useful oils include hydrocarbon mineral oils such as branch-chain isoparaffinic solvent, which are available from Esso Schweiz GmbH, located in Zurich, Switzerland under the tradename Isopar M, or other similar aliphatics such as Exoll D100, for example. The oil phase typically comprises about 15 to 30 weight percent of the emulsion. In the case of a suspension, the oil phase is typically about 40 to 60 weight percent by total weight of the suspension.

The aqueous phase of the inverse-emulsion is comprised of water that is from about 85 to 70 weight percent of the inverse-emulsion. For an inverse-suspension, the water is typically about 60 to 40 weight percent of the inverse-suspension.

In addition to water, the aqueous phase also contains the monomers to be polymerized in amounts that are typically from about 35 to 45 weight percent of the emulsion. Inverse-emulsions containing the final polymer product should typically have about 35 to 45 weight percent solid content, and somewhat more typically about 38 to 42 percent solid content. The inverse-emulsion should be substantially free of coagulum and have less than about 1 percent coagulum based on the total weight of the polymer. Polyacrylamide polymers prepared in accordance with the invention are typically linear or branched and have high molecular weights in excess of 7,000,000 g/mol. It is believed that the performance of the polymers may be improved because of a light increase in the hydrophobicity of the polymers. The hydrophobicity increase may be due to the incorporation of non-reacted methacrylates into the water-soluble polymer chains. The methacrylates are used in the synthesis of the stabilizing agent and typically have a conversion between about 80 and 90%. Inverse-suspensions prepared in accordance with the invention typically have a solid content that is from about 15 to 30 weight percent based on the total weight of the suspension.

The solid content is prepared from acrylamide monomers that are polymerized with acrylic acid, sodium acrylate, or ammonium acrylate co-monomers. The amount of acrylamide monomer to the anionic co-monomers in the emulsions is typically from about 90:10 to 50:50 mol percent. In inverse-suspensions, the molar ratio is from about 10 to 30 percent for the anionic co-monomers, and 5 to 90 mol percent for the cationic co-monomers by total monomer weight in the inverse-suspension.

Suitable cationic co-monomers that are useful in the invention include, without limitation, quaternary ammoniums such as dimethylaminoethylacrylate (DMAEA), dimethylaminoethylmethacrylate (DMAEM), diallydimethylammonium chloride (DADMAC), and 3-methacrylamidepropyl trimethylammonium chloride (MAPTAC), and the like.

Examples of cationic monomers include dialkylaminoalkylacrylates and methacrylates, especially dialkylamino ethyl acrylate, and their quaternary ammonium salts, and dialkylaminoalkylacrylamides or methacrylamides and their quaternary or acid salts. Alkyl groups are generally C₁₋₄ hydrocarbons that may be either branched or straight chain. Suitable quaternary salts include, for example, quaternary ammonium salts, such as methylated quaternary ammonium salts. Specific examples of suitable cationic monomers include, without limitation, dimethyl aminoethyl acrylate methyl chloride or trimethyl aminoethyl methacrylate methyl chloride.

Examples of anionic monomers includes, e.g., acrylic acid, sodium acrylate, sodium methacrylate, ammonium acrylate, ammonium methacrylate, methacrylic acid, itaconic acid, 2-acrylamide 2-methyl propane sulphonate, sulphopropylacrylate or methacrylate or other forms and derivatives of these carboxylic or sulphonic acids.

A chain branching or crosslinking agent can be incorporated into the process of this invention. As used herein, the term “chain branching agent” means a molecule, typically a polymerizable monomer, which when incorporated in the polymerization reaction for the preparation of the polymer of this invention, is capable of causing the formation of branching side chains along the backbone of the resultant polymer. The term chain branching agent is used synonymously with the term cross linking agent. Both may be di- or multi-functional water soluble vinyl monomers, The difference is the concentration with a chain branching agent used at levels suitable to form a soluble product and a crosslinking agent used to create physically gelled systems where all or part of the polymer would be insoluble. The branching agent may be added at levels that typically range from about 1 to 30 ppm based on the total monomer level, with levels from about 5 to 25 ppm, and 15 to 30 ppm being somewhat more preferred.

Typically, a chain branching agent is a water-soluble multifunctional monomer having at least two unsaturated groups. Examples of chain branching agent include, but are not limited to, methylene-bis-acrylamide (which is often referred to as MBA), diethylene glycol diacrylate, propylene glycol dimethacrylatc, alkyl diacrylate, diallylfumarate, trimethylol-propane triacrylate and the like. One or more chain branching agents can be used. Preferably, methylene-bis-acrylamide (MBA) is used as a chain branching agent in the process of this invention. Chain branching and cross linking agents can be added in a batch or semi-batch method. Suitable chain branching and crosslinking agents and techniques are discussed in U.S. Pat. No. 6,617,402, the contents of which are hereby incorporated by reference.

In alternative embodiments, the molecular weight of the polymer can be controlled by adding of one or more chain transfer agents to the polymerization recipe. The chain transfer agent can generally be present in amounts ranging from about 0.01 to 2.0 weight percent based on the total amount of the reaction mixture or emulsion. Isopropanol can be used as a chain transfer agent in a preferred amount of from about 0.01 to 0.25 weight percent based on the total amount of the reaction mixture or emulsion. Chain transfer agents such as mercaptoethanol, propylene glycol, sodium hypophosphite, thioglycolic acid or lactic acid in preferred amounts of from about 0.01 to 2.0 weight percent based on the total amount of the reaction mixture or emulsion can also be employed.

The aqueous phase can also contain additional additives such as sequestering agents, acids, salts, and the like.

In addition to the stabilizing agents described above, the inverse-emulsions or inverse-suspensions may also contain one or more conventional emulsifiers that are oil-soluble and substantially water-insoluble. Typically, these know emulsifiers or surfactants have an HLB that is from about 2 to 11. For an inverse-emulsion, the conventional surfactants preferably have an HLB in the range from about 3 to 10.5, and more preferably from about 3.5 to 10.2. In the case of an inverse suspension, the conventional surfactants preferably have a HLB in the range from about 3 to 6, and more preferably in the range from about 3 to 4.

Useful emulsifiers or surfactants include, without limitation, sorbitan esters of fatty acids, alcanol amides, fatty acid glycerides, glycerin ester, as well as polyethoxylated derivatives of the above mentioned compounds and any other well-known emulsifier. Suitable conventional surfactants include, but are not limited to, sorbitan esters of fatty acids (e.g. sorbitan monooleate, sorbitan sesquioleate), alkanolamides, fatty acid glycerides, glycerine esters, as well as ethoxylated versions of the above and any other well know emulsifier, including polymeric dispersants.

When present, the amount of conventional surfactant in the inverse-emulsion is typically from about 1.5 to 5 weight percent based on the total weight percent of the emulsion, with 1.5 to 2.5 weight percent being somewhat more preferred. If present, the amount of conventional surfactant in the inverse-suspensions is typically from about 0.1 to 0.5 weight percent based on the total weight of the suspension. A fatty alcanol amide can be added to help reduce the viscosity of the emulsion. Fatty alcanol has a strong chain transfer effect that reduces the intrinsic viscosity of the polymer measured in 0.5 mol/L NaCl solution at 25° C.

The emulsion can also contain sequestering agents. Ethylenediamine tetracetic acid (EDTA) and its salts are particularly useful as sequestering agents. Typically, the amount of sequestering agent is from about 0.02 to 0.03 weight percent based on the total weight of the emulsion.

Ionic salts can also be added to the emulsion or suspension to increase the performance of the stabilizing agent. Ionic salts are discussed in U.S. Pat. No. 4,506,602, the contents of which are incorporated by reference. Different inorganic salts can also be employed, such as sodium sulfate, ammonium chloride, and the like.

The polymerization reaction process of this invention can be carried out in the presence of a conventional polymerization initiator. The initiator can be oil or water-soluble. Examples of suitable water-soluble initiators include, e.g., 2,2′-azobis-(2-amidinopropane)dihydrochloride, 4,4′-azobis-(4-cyanopentanoic acid), or redox system such as potassium bromatee/sodium meta bisulfate. Oil-soluble initiators include, e.g., dibenzoyl peroxide, dilauryl peroxide or tert-butyl peroxide, or azo compounds such as 2,2′-azobisisobutyrate and 2,2′-azobis-(4-methoxy-2,4-dimethylvaleronitrile), and combinations thereof. Typically, the amount of initiator used is from about 0.0005 to 0.5% by weight of the total emulsion or suspension, and somewhat more typically, from about 0.01 to 0.05 weight percent.

The polymerization temperature can be selected based on the decomposition kinetics of the initiator used, and may be from about 35° C. to 60° C. For suspensions the polymerization temperature is typically from about 20° C. to 60° C. To reduce the residual monomer content, it is also possible to increase the temperature during the course of the polymerization. Alternatively, it is also possible to use additional initiators during and at the end of the polymerization. The polymerization initiation temperature is typically about 40° C.

The polymerization reaction is typically carried out at a pH of about 6.0 to 7.0. Suitable amounts of sodium hydroxide or ammonium hydroxide solutions can be added to the primary emulsion to adjust to the desired pH. For cationic suspensions the preferred pH is from about 3.5 to 4.5.

The polymerization reaction typically is completed in about 4 to 6 hours. The reaction is carried out at atmospheric pressure under an inert atmosphere such as nitrogen. Overall, intrinsic viscosities for polymers produced via inverse-emulsion polymerization were typically from about 11-13 dl/g or greater, while those based on inverse-suspension polymerization were from about 11-21 dl/g.

The water-in-oil emulsions of the present invention can be self-inverting or can be inverted with the addition of a wetting agent or breaker surfactant. These wetting agents can be added to the water-in-oil emulsion or can be added to the water into which the emulsion is introduced. Preferably used wetting agents for inverting the water-in-oil emulsions are ethoxylated nonylphenol having a degree of ethoxylation between 5 to 20 or propoxylate fatty alcohols of 10 to 22 carbons, having a degree of alkoxylation between 5 to 20. Typically, the wetting agent is added in an amount that is equal to about 1.5 to 3.5 percent of the total weight of the emulsion, and somewhat more typically, about 1.5 to 2.5 percent.

Inverse-emulsions and inverse-suspensions prepared in accordance with the invention may be used to prepare dry polymeric powders. In the present invention, the inverse-suspensions were permitted to settle, after the agitation was stopped, for a period of time from minutes up to 1 to 2 hours. The organic phase can then be decanted and the polymer washed with acetone. In some embodiments, the inverse-suspension can be precipitated in acetone so that the oil phase is substantially removed. Failure to remove the oil phase may result in decreases in the solubility of the final polymeric product obtained. The suspensions can then be dried in a vacuum drier and crushed, either alone or in the presence of acetone. For inverse-suspension/gels, separation can be performed by decantation and filtration, followed by washing with acetone and drying. Inverse-emulsions may be kept in liquid form with the exception of some polymers that may be precipitated in acetone to provide a powder for analytical methods.

The invention may also be used to prepare both linear or branched polymeric powders from inverse-suspensions having cationic polymerizable monomers. The branched polymers are typically water-soluble. In all cases, the recipe for preparing branched cationics via inverse-suspension is very similar in terms of linear materials, although the inverse-suspension may also comprise difunctional monomer and chain transfer agents that are used to help ensure that the resulting polymer is branched and not crosslinked.

### EXAMPLES

The following examples are provided for the purpose of illustration and should not be considered as limiting the invention in any way. Examples 1-13 describe the stabilizing agent and its application in inverse emulsion polymerization. Examples 14-15 describe the use of the stabilizing agent in the inverse-suspension polymerization of anionic monomers. Examples 16-17 describe the use of the stabilizing agent in the inverse-suspension polymerization of cationic monomers.

### Preparation of the Stabilizing Agent (Examples -10)

### Example 1a

### Preparation of a Stabilizing Agent

A polymeric stabilizing agent, (IB 14 in Table 1a) was polymerized based on 86 mol % of a mixture of methacrylates having C16 or C18 alkyl chain length (with a ratio of C₁₆:C₁₈ of 25:75) and 14 mol % of acrylic acid. 20 parts of the stabilizing agent IB 14 are dissolved in 80 parts of aliphatic hydrocarbon (Isopar M) as a solvent. The solution is charged in a 0.5 L glass rector, equipped with mechanical stirrer, cooling-heating jacket and connected to a nitrogen line. The reaction mixture is purged/degassed continuously for 1 hour with nitrogen, the temperature is increased up to 60° C. and the reaction is initiated with addition of 0.0005 parts of 2,2′-azobis(2,4dimethylvaleronitrile). After 3 hours the temperature is increased up to 90° C. and is kept constant for another 5 hours to complete the polymerization reaction. The obtained copolymers are used in a solution as received.

### Example 1b

### Preparation of Acrylamide-Sodium Acrylate Copolymer by Inverse-Emulsion Copolymerization

This example illustrates the synthesis of acrylamide copolymer comprising 20 mol percent sodium acrylate, based on the total molar monomer content.

To a vessel equipped with a stirrer are added 213.2 grams of aliphatic solvent, 12 grams of sorbitan monoisostearate, 8 grams of polyoxyethylenated(20)sorbitan trioleate, and 4.2 grams dry polymer of the aforementioned stabilizing agent from example 1a (EB 14) as 20 wt % solution in aliphatic hydrocarbon. The mixture is stirred at 300 rpm for 5 minutes.

In a separate vessel also equipped with a stirrer, the aqueous phase is prepared containing 285.5 grams of acrylamide, 72.4 grams of acrylic acid, 0.25 grams of EDTA (sodium salt), 0.2 grams of potassium bromate, 10 grams of ammonium chloride, and 329.9 grams of demineralized water.

The aqueous phase is stirred for about 30 minutes at 250 rpm and is buffered to a pH of 7.0 by adding 50 wt % water solution of sodium hydroxide. The aqueous phase is then transferred to the oil phase under stirring. The mixture is pre-emulsified at 300 rpm for 5 minutes and after that emulsified for 30 seconds at 8000 rpm. The resulting emulsion is added to a 1.5 L stainless steel reactor equipped with a stirrer and connected to a nitrogen line. The emulsion is continuously sparged with nitrogen at a flow rate of 1.5 L/min for 45 minutes. The temperature is increased up to 40° C. and the reaction is initiated by 0.2 grams of 2,2′-azobis(2,4dimethylvaleronitrile), an oil-soluble free radical initiator, dissolved in 0.45 grams of xylene, added through a septum in the top of the reactor. The initiation of polymerization is noticed by an increase in temperature (exothermal reaction) of 0.2° C. or more under the influence of automatic temperature control. The reaction is maintained at 40° C. for 6 hours. At the end of the 6 hours, the polymerization temperature is increased up to 55° C. and 1.2 grams of sodium metabisulfite, dissolved in 2.8 grams of demineralized water are added to the reactor to reduce the residual acrylamide concentration to below 250 ppm. After cooling, 35 grams of ethoxylated nonylphenol are slowly added to the emulsion as an inverting surfactant. The resultant inverse-emulsion contains 35 wt % of active material. The polymer in aqueous solution has an intrinsic viscosity (measured in 0.5 mol/L sodium chloride at 25° C.) of 8.0 dl/g.

### Examples 2-4

The aqueous phase contains: 285.5 grams of acrylamide, 72.3 grams of acrylic acid, 0.2 grams of potassium bromate, 0.25 grams EDTA (sodium salt), 9.8 grams of ammonium chloride, 0.2 grams of octadecyltrimethylammonium chloride, and 329.9 grams of demineralized water. The aqueous phase is adjusted to a pH of 7.0 with 50 wt % solution of sodium hydroxide.

The continuous phase contains respectively: 209.2 grams of aliphatic hydrocarbon, 12 grams of sorbitan monostearate, 8 grams of polyoxyethylenated(20)sorbitan trioleate and 5.0 grams dry polymer of stabilizing agent from example 1a (IB 14) as a 20 wt % solution in Isopar-M.

The procedure for preparing the emulsion and the polymerization reaction is the same as in Example 1.

The molecular weight characteristics are improved compared with the Example 1 and the final emulsions are substantially free of coagulum. The intrinsic viscosities are listed in Table 2, and were measured at 25° C. in 0.5 M NaCl.

TABLE 2
Viscosity and Actives Level of Examples 2-4

| | Intrinsic viscosity | Active material |
|---|---|---|
| Example No. | (dl/g) | (wt %) |
| 2 | 13.7 | 35 |
| 3 | 13.0 | 35 |
| 4 | 11.0 | 35 |

### Examples 5-7

Examples 5-7 illustrate the change of the molecular weight characteristics of the polymers when 0.1 wt % of the stabilizing agent by the total weight of the emulsion is replaced with fatty alcanolamide (e.g., Witcamide 511, which is a commercial product) to reduce the viscosity of the primary emulsion and to improve the temperature control during the polymerization reaction. In all the examples, intrinsic viscosities were measured at 25° C. in 0.5 M NaCl.

TABLE 3
Viscosity and Actives Level of Examples 5-7

| | Intrinsic viscosity | Active material |
|---|---|---|
| Example No. | (dl/g) | (wt %) |
| 5 | 9.0 | 40 |
| 6 | 9.0 | 40 |
| 7 | 8.5 | 40 |

### Example 8

The procedure of the preparation of the emulsion and the polymerization process is the same as in the aforementioned examples. The amounts of the conventional stabilizers were changed as follows: The percentage of sorbitan monoisostearate is increased up to 1.4 wt % based on the total weight of the emulsion, and the amount of the more hydrophilic poly(ethylene oxide)-(20)-sorbitan trioleate is decreased to 0.3 wt % based on the total weight of the emulsion. The sodium acrylate content in this example is 30 mol percent based on the total molar content of the monomers and the percentage of the actives is 42 wt % based on the total weight. The intrinsic viscosity measured at 25° C. in 0.5 M NaCl is 16.5 dl/g. The temperature control is decreased because of the high viscosity of the primary emulsion.

### Example 9

Example 9 illustrates the synthesis of acrylamide-sodium acrylate copolymer with 40 mol percent acrylic acid content based on the total monomer content and 40 wt % actives.

The aqueous phase contains: 220 grams of acrylamide, 149.7 grams of acrylic acid preliminary neutralized to pH of 7.0 with a solution of ammonium hydroxide, 154.7 grams of demineralized water, 0.2 grams of potassium bromate, 0.25 grams of EDTA (sodium salt), 1 gram of ammonium chloride, and 0.2 grams of octadecyltrimethylammonium chloride.

The oil phase contains: 219.2 grams of aliphatic solvent, 18.0 grams of sorbitan monoisostearate, 2.5 grams of polyoxyethylenated(20)sorbitan trioleate, and 2.0 grams of dry polymer stabilizing agent (IB 14 from example 1a) as a 20 wt % solution. The procedure for preparation of the emulsion and the polymerization process is the same as in Example 1. The resulting emulsion is substantially free of coagulum and the intrinsic viscosity measured at 25° C. in 0.5 M NaCl is 14.7 dl/g.

### Example 10

In this example, the amounts of the reagents and the conditions of the process are the same as in Example 9, but the molar content of the acrylic acid is increased up to 50 mol percent based on the total molar monomer content. The final emulsion has a low content of coagulum and the intrinsic viscosity measured at 25° C. in 0.5 M NaCl is 20 dl/g.

### Application of the Stabilizing Agent in the Inverse-Emulsion Polymerization of Anionic Monomers (Examples 11-14)

### Example 11

Example 11 illustrates the scale up of the process with improved temperature control during the polymerization reaction and with a final emulsion substantially free of coagulum and containing 40 wt % of actives.

The aqueous phase contains: 6124.7 grams of acrylamide, 2661.8 grams of acrylic acid (30 mol percent content by total molar monomer content), 5188.70 grams of demineralized water, 4.0 grams of potassium bromate, 4.0 grams of EDTA (sodium salt), 24 grams of ammonium chloride, 15 grams of isopropanol, and 3.0 grams of octadecyltrimethylammonium chloride. 2844.6 grams of 50 wt % sodium hydroxide solution are added to adjust pH to 7.0.

The oil phase contains: 5320.6 grams of aliphatic hydrocarbon, 422.4 grams of sorbitan mono isostearate, 57.6 grams of polyoxyethylene sorbitol hexaoleate and 48.0 grams dry polymer stabilizing agent (from Example 1a, IB 5000) as a 20 wt % solution.

The general procedure for preparing the emulsion is as before. The initiation is performed by addition of 2.5 grams of 2,2′-azobis(2,4dimethylvaleronitrile). To decrease the concentration of the residual acrylamide, 25.0 grams of sodium metabisulfite in 60.0 grams of demineralized water are added after 6 hours. The intrinsic viscosity of the resulting polymer measured at 25° C. in 0.5 M NaCl is 13.8 dl/g.

### Example 12 (Comparative)

The amounts of the reagents and the procedure are the same as in Example 11, but the stabilizing agent (from Example 1a) is replaced with an equivalent amount of additional sorbitan monostearate, the more hydrophobic conventional stabilizer used. The final emulsion contains a large amount of water-insoluble polymer (more than 20 wt % based on the total weight of the emulsion).

### Example 13

The conditions and the amounts of the reagents are the same as in Example 10 but the emulsion is without isopropanol. The temperature control during the reaction is very good and the final emulsion is substantially free of coagulum. The resulting intrinsic viscosity measured at 25° C. in 0.5 M NaCl is 15.7 dl/g.

### Use of the Stabilizing Agent in the Inverse-Suspension Polymerization of Anionic Monomers (Examples 14-15)

The following examples illustrate the preparation of inverse-suspensions of anionic acrylamide based copolymers using the stabilizing agents (synthesized as in Example 1a) alone or in combination with low HLB conventional stabilizers.

### Example 14

The aqueous phase contains: 115.428 grams of acrylamide, 49.58 grams of acrylic acid, 1 grams of sodium sulfate, 0.0508 grams of EDTA-disodium salt, 0.0508 grams of octadecyltrimethylammonium chloride, and 230.848 grams of demineralized water. The pH is adjusted to 6.5 with 50 wt % sodium hydroxide solution.

The oil phase contains: 3.48 grams dry methacrylic acid based copolymer with the following composition: 10 molar percent methacrylic acid and a mixture of alcohol methacrylates having C16 or C18 alkyl chains in a ratio of C₁₆:C₁₈ of 25:75 (stabilizing agent MA 10 from Table 1a), as a 20 percent solution and 528 grams aliphatic hydrocarbon.

The water phase is quickly added to the oil phase and pre-emulsified for 5 minutes and thereafter homogenized for 2 minutes with a laboratory homogenizer.

The suspension is poured into 1.5 L stainless steel reactor. The reaction mixture is degassed for 1 hour with nitrogen, the temperature is adjusted to 35° C. and the polymerization is influenced by addition of 0.025 grams of 70 percent water solution of t-butylhydroperoxide and followed by continuous addition of 0.014 grams sulfuric dioxide in 5 grams of aliphatic hydrocarbon for 25 minutes. The temperature is kept 35° C. during the first 3 hours and is increased for an additional 1 hour up to 55° C. The resulting fine gel-suspension is separated by filter centrifuge and dried in vacuum drier. The dry polymer has an intrinsic viscosity of 20 dl/g measured in 0.5 M NaCl solution at 25° C.

### EXAMPLE 15

Example 15 illustrates the scale up of an inverse-suspension copolymerization process for synthesis of anionic high molecular acrylamide based copolymers in a 25 kg reactor. The aqueous phase contains: 2564.44 grams of acrylamide, 1100 grams of acrylic acid, 20 grams of sodium sulfate, 2 grams of EDTA (disodium salt), 1.8 grams of octadecyltrimethylammonium chloride, and 4136.6 grams of demineralized water.

The oil phase contains: 106.4 grams of dry methacrylic acid based copolymer (from example 14, i.e., stabilizing agent MA 10 from Table 1a) as a 20 percent solution and 10,468 grams aliphatic hydrocarbon as solvent.

The components of the aqueous phase are charged into the reactor and are dissolved for 20 minutes at 25° C. and the pH is adjusted to 6.5 by addition of sodium hydroxide solution.

In a separate vessel the oil phase is prepared. The water phase is transferred to the oil phase and pre-emulsified for 20 minutes. The prepared suspension is returned to the reactor and is degassed for 20 minutes under vacuum, and for 1.5 hours by purging with a nitrogen at flow rate of 1.6 L/min. 0.107 grams of t-butylhydroperoxide (70 percent water solution) are dissolved in 1 gram of demineralized water and is injected into the suspension. The polymerization is initiated by the continuous addition for over 20 minutes of a solution of 0.082 grams (97%) of sodium persulfate dissolved in 5 grams demineralized water. The polymerization starts at 25° C. The temperature is allowed to reach 50° C. and is kept constant for total time of 3 hours.

The resulting polymer has an intrinsic viscosity of 20 dl/g measured in 0.5 M NaCl solution at 25° C.

### Application of the Stabilizing Agent in the Inverse-Suspension Polymerization of Cationic Monomers (Examples 16-17)

### Example 16

Example 16 presents a synthesis of cationic acrylamide based polymer containing molar percent of acryloylethyl trimethyl ammonium chloride.

58.22 grams of acrylamide and 66.58 grams of acryloylethyl trimethyl ammonium chloride are dissolved in 118 grams of demineralized water. Additionally 0.026 grams of EDTA and 0.026 grams of octadecyltrimethylammonium chloride are added and the pH is adjusted to 3.5 by addition of adipic acid.

The oil phase is prepared by dilution of 1.7 grams of the aforementioned dry stabilizing agent (from example 14) as a 20 wt % solution with 300 grams of aliphatic hydrocarbon.

The preparation of the suspension is as described above. After degassing, the polymerization is initiated by addition of 0.025 grams of 70 percent water solution of t-butylhydroperoxide and followed by continuous addition of 0.02 grams of sodium methabisulfite in 5 grams of demineralized water for 25 minutes at 35° C. After 3 hours the temperature is increased up to 55° C. for another hour. The final suspension is completely free from any agglomeration and is separated by centrifugation. The polymer is dried under vacuum. The intrinsic viscosity is 18 dl/g measured in 0.5 M NaCl at 25° C.

### Example 17

The water phase is prepared by dissolving 64.6 grams of acrylamide and 26.56 grams of acryloylethyl trimethyl ammonium chloride in 157.5 grams of demineralized water, containing 0.026 grams of EDTA and 0.01 grams of octadecyltrimethylammonium chloride. The pH is adjusted to 3.5 by addition of adipic acid. The oil phase contains: 0.5 grams dry stabilizing agent (from example 14) as a 20 wt % solution, 1.3 grams of sorbitan suesquioleate dissolved in 301 grams of aliphatic hydrocarbon. The water phase is quickly added to the oil phase and the suspension is mixed for 10 minutes at 400 rpm. After degassing for 1 hour, polymerization is started by addition of 0.025 grams of t-butylhydroperoxide and 0.014 grams sulfur dioxide dissolved in 5 grams aliphatic hydrocarbon as solvent. The initiators are continuously added for 25 minutes at 25° C. The temperature is allowed to reach 45° C. for 1 hour and after that is increased for another 2 hours to 50° C. The resulting suspension is free from agglomeration and is left for 30 minutes to settle. It is then separated by decantation and vacuum filtration. After drying the polymer has an intrinsic viscosity of 12 dl/g measured at 25° C. in 0.5 M NaCl.

Many modifications and other embodiments of the invention set forth herein will come to mind to one skilled in the art to which the invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An inverse-emulsion and inverse-suspension polymerization stabilizer comprising:
a hydrophobic mixture of methacrylate monomers having the following formula (A) 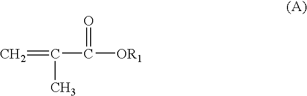
wherein R¹ is an alkyl group from 14 to 20 carbon atoms; and a hydrophilic monomer component having the following formula (B) 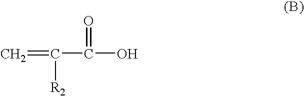
wherein R₂ is CH₃ or H, and
wherein the stabilizing agent has a number average molecular weight that is from about 500 to 50,000 g/mol.

2. The stabilizing agent according to claim 1, wherein the amount of component (A) to component (B) is from about 95:5 to 30:70.

3. The stabilizing agent according to claim 1, wherein the amount of component (A) to component (B) is from about 95:5 to 80:20.

4. The stabilizing agent according to claim 1, wherein the amount of component (A) to component (B) is from about 90:10 to 80:20.

5. The stabilizing agent according to claim 1, wherein the mixture of methacrylate copolymers are comprised of linear alkylmethacrylates.

6. The stabilizing agent according to claim 5, wherein the mixture of methacrylate monomers includes tetradecyl methacrylate, hexadecyl methacrylate, octadecyl methacrylate, or eicosyl methacrylate.

7. The stabilizing agent according to claim 1, wherein the mixture of methacrylate monomers are about 90 to 98% methacrylates having alkyl groups that are 16 to 18 carbon atoms in length.

8. The stabilizing agent according to claim 1, wherein component (B) is comprised of a mixture of acrylic acid and methacrylic acid.

9. The stabilizing agent according to claim 1, wherein the intrinsic viscosity of stabilizing agent copolymer is from about 0.07 to 0.35 dl/g, said intrinsic viscosity measured at 35° C. in tetrahydrofuran by GPC with a viscometric detector.

10. An inverse-emulsion polymerizable stabilizing blend comprising:
a stabilizing agent having a hydrophobic component comprised of a mixture of methacrylate monomers and a hydrophilic component comprised of acrylic acid, methacrylic acid, or blends thereof, and having a number average molecular weight that is from about 500 to 50,000 g/mol and weight average molecular weight from 50,000 to 100,000 g/mol; and
one or more surfactants having an HLB from about 2 to 11.

11. The stabilizing blend according to claim 10, wherein the surfactant is sorbitan esters of fatty acids, alcanol amides, fatty acid glycerides, glycerin esters, or polyethoxylated derivatives thereof.

12. The stabilizing blend according to claim 10, wherein the surfactant has an HLB from about 3.5 to 6 and is present in the blend in an amount from about 50 to 80 weight percent based on the total weight of the blend.

13. The stabilizing blend according to claim 10, wherein the surfactant has an HLB from about 9 to 11 and is present in the blend in an amount from about 10 to 30 weight percent based on the total weight of the blend.

14. A polymerizable inverse-emulsion comprising:
i) an oil phase;
ii) an aqueous phase;
iii) an acrylamide-based monomer; and
iv) a stabilizing agent that is comprised of a mixture of methacrylate ester monomers and methacrylic acid or acrylic acid co-monomers, the mixture of methacrylate esters having alkyl moieties from 14 to 20 carbon atoms, and wherein the stabilizing agent has a number average molecular weight that is from about 500 to 50,000 g/mol and weight average molecular weight from 50,000 to 100,000 g/mol.

15. The inverse-emulsion according to claim 14, further comprising one or more conventional surfactant having an HLB from about 2 to 11, said one or more conventional surfactant being present in the amount from about 1.5 to 5 weight percent, based on the total weight of the inverse-emulsion.

16. The inverse-emulsion according to claim 14, wherein 90 to 98 percent of the mixture of methacrylate esters have alkyl moieties from 16 to 18 carbon atoms.

17. The inverse-emulsion according to claim 14, wherein the methacrylate monomers and acrylic acid or methacrylic acid co-monomers are in a 95:5 to 30:70 ratio.

18. The inverse-emulsion according to claim 14, wherein the amount of stabilizing agent is from about 0.1 to 2.5 weight percent based on the total weight of the inverse-emulsion.

19. The inverse-emulsion according to claim 14, wherein the acrylamide-based polymer is polymerized from acrylamide monomers that are polymerized with anionic co-monomers.

20. The inverse-emulsion according to claim 19, wherein the anionic co-monomers are acrylic acid, sodium acrylate, sodium methacrylate, ammonium acrylate, ammonium methacrylate, methacrylic acid, itaconic acid, 2-acrylamide 2-methyl propane sulphonate, sulphopropylacrylate or methacrylate, or derivatives thereof.

21. The inverse-emulsion according to claim 14, wherein the inverse-emulsion comprises from about 35 to 45 weight percent polymeric solid content based on the total weight of the inverse-emulsion.

22. The inverse-emulsion according to claim 14, wherein the inverse-emulsion has substantially no coagulum.

23. The inverse-emulsion according to claim 14 further comprising a sequestering agent, initiator, or chain transferring agent.

24. The inverse-emulsion according to claim 14, wherein the intrinsic viscosity of the inverse-emulsion measured at 25° C. in 0.5 M NaCl is about 11 dl/g or greater.

25. The inverse-emulsion according to claim 14, wherein the stabilizing agent contains 0.1 weight percent fatty alcanolamide, based on the total weight of the inverse-emulsion.

26. An inverse-suspension polymerizable stabilizing blend comprising:
a stabilizing agent having a hydrophobic component comprised of a mixture of methacrylate monomers and a hydrophilic component comprised of acrylic acid, methacrylic acid, or blends thereof, and having a number average molecular weight that is from about 500 to 50,000 g/mol and weight average molecular weight from 50,000 to 100,000 g/mol; and
one or more surfactants having an HLB from about 3 to 6, said one or more surfactants being present in the blend in an amount up to about 85 weight percent based on the total weight of the blend.

27. A polymerizable inverse-suspension comprising:
i) an oil phase;
ii) an aqueous phase;
iii) an acrylamide-based anionic monomer; and
iv) a stabilizing agent that is comprised of a mixture of methacrylate ester monomers and methacrylic acid or acrylic acid co-monomers, the mixture of methacrylate esters having alkyl moieties from 14 to 20 carbon atoms, and wherein the stabilizing agent has a number average molecular weight that is from about 500 to 50,000 g/mol and weight average molecular weight from 50,000 to 100,000 g/mol.

28. The inverse-suspension according to claim 27, further comprising one or more conventional surfactants having an HLB between 3 and 6, said one or more conventional surfactants being present in the amount from about 0.1 to 0.5 weight percent, based on the total weight of the inverse-suspension.

29. The inverse-suspension according to claim 27, wherein 90 to 98 percent of the mixture of methacrylate esters have alkyl moieties from 16 to 18 carbon atoms.

30. The inverse-suspension according to claim 27, wherein the methacrylate copolymers and acrylic acid or methacrylic acid monomers are in a 95:5 to 30:70 ratio.

31. The inverse-suspension according to claim 27, wherein the amount of stabilizing agent present in the inverse suspension is up to 1 weight percent based on the total weight of the suspension.

32. The inverse-suspension according to claim 27, wherein the acrylamide-based polymer is polymerized from acrylamide monomers that are polymerized with cationic or anionic co-monomers.

33. The inverse-suspension according to claim 27, wherein the anionic co-monomers are acrylic acid, sodium acrylate, sodium methacrylate, ammonium acrylate, ammonium methacrylate, methacrylic acid, itaconic acid, 2-acrylamide 2-methyl propane sulphonate, sulphopropylacrylate or methacrylate, or derivatives thereof.

34. A polymerizable inverse-suspension comprising:
i) an oil phase;
ii) an aqueous phase;
iii) an acrylamide-based cationic monomer; and
iv) a stabilizing agent that is comprised of a mixture of methacrylate ester monomers and methacrylic acid or acrylic acid co-monomers, the mixture of methacrylate esters having alkyl moieties from 14 to 20 carbon atoms, and wherein the stabilizing agent has a number average molecular weight that is from about 500 to 50,000 g/mol and weight average molecular weight from 50,000 to 100,000 g/mol.

35. The inverse-suspension according to claim 34, further comprising one or more conventional surfactants having an HLB between 3 and 6, said one or more conventional surfactants being present in the amount from about 0.1 to 0.5 weight percent, based on the total weight of the inverse-suspension.

36. The inverse-suspension according to claim 34, further comprising a branching agent in the amount of about 1-30 ppm based on total monomer content.

37. The inverse-suspension according to claim 34, wherein the cationic co-monomers are dimethylaminoethylacrylate, dimethylaminoethylmethacrylate, diallydimethylammonium chloride, or 3-methacrylamidepropyl trimethylammonium chloride.

38. The inverse-suspension according to claims 34, wherein the inverse-suspension comprises from about 15 to 30 weight percent polymeric solid content based on the total weight of the inverse-suspension.

39. The inverse-suspension according to claims 34, wherein the inverse-suspension has substantially no coagulum.

40. The inverse-suspension according to claims 34, further comprising a sequestering agent, initiator, chain transferring agent, cross linking agent, branching agent, or an alkyl quaternary ammonium salt.

41. The inverse-suspension according to claim 34, wherein the intrinsic viscosity of the inverse-suspension measured at 25° C. in 0.5 M NaCl is from about 11 to 21 dl/g.

42. A dry polymeric powder prepared by:
a) preparing an inverse-suspension comprising:
i) an oil phase;
ii) an aqueous phase;
iii) acrylic-based monomers;
iv) a stabilizing agent that is comprised of a mixture of methacrylate ester monomers and methacrylic acid or acrylic acid co-monomers, the mixture of methacrylate esters having alkyl moieties from 14 to 20 carbon atoms, and wherein the stabilizing agent has a number average molecular weight that is from about 500 to 50,000 g/mol and weight average molecular weight from 50,000 to 100,000 g/mol;
b) initiating polymerization of the acrylic-based monomers;
c) removing the oil phase; and
d) drying the polymeric product.

43. A dry polymeric powder according to claim 42, wherein the acrylic-based monomers include monomers selected from the group consisting of non-ionic co-monomers, anionic co-monomers, cationic co-monomers, and combinations thereof.

44. A dry polymeric powder according to claim 42, wherein the step of initiating polymerization of the acrylic-based monomers further includes producing a branched polymer.

45. A process for preparing a stabilizing agent for stabilizing an inverse-emulsion or inverse-suspension comprising:
polymerizing a mixture of linear alkylmethacrylates having alkyl moieties that are14 to 20 carbon atoms with an acrylic acid or methacrylic acid monomers or mixtures thereof to produce a copolymer having a numbered average molecular weight from about 500 to 50,000 g/mol.

46. The process according to claim 45, wherein the mixture of linear alkylmethacrylates is comprised of about 90 to 98 percent linear alkylmethacrylates having alkyl moieties from 16 to 18 carbons.

47. The process according to claim 45, wherein the amount linear alkylmethacrylates to acrylic acid or methacrylic acid monomers is from about 95:5 to 80:20.

48. A process for preparing a polymerizable inverse-emulsion having about 40 to 45 weight percent acrylic monomers based polymers, said process comprising:
i) forming an aqueous phase solution having acrylamide based monomers;
ii) forming an oil phase having a stabilizing agent as described in claim 1;
iii) emulsifying the aqueous solution in the oil phase to form an inverse-emulsion; and
iv) initiating polymerization of the monomers.

49. The process according to claim 48, wherein the aqueous phase comprises 50 to 90 mol percent acrylamide monomers and 50 to 10 mol percent anionic co-monomers.

50. The process according to claim 48, wherein the oil phase further includes the stabilizing agent in combination with one or more conventional surfactants having an HLB from about 2 to 11, said one or more conventional surfactants being present in the combination in an amount from about 80 to 90 weight percent based on the total weight of the combination.

51. The process according to claim 50, wherein the combination of the stabilizing agent and one or more conventional surfactants are present in the emulsion in an amount that is from about 1 to 2.5 weight percent based on the total weight of the inverse-emulsion.

52. The process according to claim 48, wherein the stabilizing agent comprises a mixture of alkylmethacrylates monomers and methacrylic or acrylic acid co-monomers, the mixture of alkylmethacrylates having about 90 to 98 percent alkyl moieties being 16 to 18 carbon atoms in length.

53. A process for preparing a polymerizable inverse-suspension having about 15 to 30 weight percent acrylic monomers based polymers, said process comprising:
i) forming an aqueous phase solution having acrylamide based anionic or cationic co-monomers;
ii) forming an oil phase having a stabilizing agent as described in claim 1;
iii) emulsifying the aqueous solution in the oil phase to form an inverse-suspension; and
iv) initiating polymerization of the monomers.

54. The process according to claim 53, wherein the oil phase further includes the stabilizing agent in combination with one or more conventional surfactants having an HLB from about 3 to 6, said one or more conventional surfactants being present in the combination in an amount up to about 85 weight percent based on the total weight of the combination.

55. The process according to claim 54, wherein the combination of the stabilizing agent and conventional surfactant are present in the inverse-suspension in an amount that is from about 0.1 to 1 weight percent based on the total weight of the inverse-suspension.

56. The process according to claim 53 wherein the anionic co-monomers are acrylic acid, sodium acrylate, sodium methacrylate, ammonium acrylate, ammonium methacrylate, methacrylic acid, itaconic acid, 2-acrylamide 2-methyl propane sulphonate, sulphopropylacrylate or methacrylate, or derivatives thereof.

57. The process according to claim 53, wherein the cationic co-monomers are dimethylaminoethylacrylate, dimethylaminoethylmethacrylate, diallydimethylammonium chloride, or 3-methacrylamidepropyl trimethylammonium chloride.

58. The process according to claim 53, wherein the stabilizing agent is comprised of a mixture of alkylmethacrylates monomers and methacrylic or acrylic acid co-monomers, the mixture of alkylmethacrylates having about 90 to 98 percent alkyl moieties being 16 to 18 carbon atoms in length.
